(19) United States
(12) Patent Application Publication
(10) Pub. No.: US 2019/0280424 A1
(43) Pub. Date: Sep. 12, 2019

(54) RUBBER BOOT AND CONNECTOR

(71) Applicant: Sumitomo Wiring Systems, Ltd., Yokkaichi (JP)

(72) Inventors: Masayuki Obata, Yokkaichi (JP); Mari Teramoto, Yokkaichi (JP)

(21) Appl. No.: 16/297,784

(22) Filed: Mar. 11, 2019

(30) Foreign Application Priority Data
Mar. 9, 2018 (JP) 2018-042724

(51) Int. Cl. H01R 13/52

(52) U.S. Cl. CPC H01R 13/5216; H01R 13/521

(57) ABSTRACT

A rubber boot (21) includes a tubular surrounding portion (22) to be externally fit to a housing (10) having a lock arm (17) disposed on an outer peripheral surface, a pressing portion (28) formed in a part corresponding to an unlocking portion (20) of the lock arm (17), out of an outer periphery of the tubular surrounding portion (22), and configured to press the unlocking portion (20) in an unlocking direction, a finger placing portion (29) disposed at a position opposite to the pressing portion (28) across the housing (10), out of the outer periphery of the tubular surrounding portion (22), and configured to receive a pressing force applied to the pressing portion (28), and a projection (30) disposed in a part adjacent to the finger placing portion (29) on the outer periphery of the tubular surrounding portion (22) and projecting from the finger placing portion (29).

### BACKGROUND

### Field of the Invention

The invention relates to a rubber boot and a connector.

### Related Art

Japanese Unexamined Patent Publication No. 2011-044303 discloses a rubber boot to be fit externally to a housing that has a lock arm formed on an outer surface. To unlock the lock arm, a worker places a thumb on the part of the outer surface of the rubber boot corresponding to the unlocking portion and places an index finger on a part of the outer surface of the rubber boot opposite to the unlocking portion across the housing. However, the part where the index finger is placed is bulging into a projection. Thus, the index finger deviates from the bulging projection when the fingers are strained for an unlocking operation.

The present invention was completed on the basis of the above situation and aims to improve workability.

### SUMMARY

A first aspect of the invention relates to a rubber boot that includes a tubular surrounding portion to be fit externally to a housing. A lock arm is disposed on an outer peripheral surface of the housing. A pressing portion is formed on a part of the lock arm corresponding to an unlocking portion of the lock arm. The pressing portion is configured to press the unlocking portion in an unlocking direction. A finger placing portion is disposed at a position opposite to the pressing portion across the housing and is configured to receive a pressing force applied to the pressing portion. A projection is disposed in a part adjacent to the finger placing portion on the outer periphery of the tubular surrounding portion and projects from the finger placing portion.

A second aspect of the invention relates to a connector that includes a housing having a lock arm disposed on an outer peripheral surface and a rubber boot including a tubular surrounding portion to be fit externally to the housing. A pressing portion is formed in a part corresponding to an unlocking portion of the lock arm and is configured to press the unlocking portion in an unlocking direction. A finger placing portion is disposed at a position opposite to the pressing portion across the housing and is configured to receive a pressing force applied to the pressing portion. A projection is disposed in a part adjacent to the finger placing portion on the outer periphery of the tubular surrounding portion and projects radially from the finger placing portion.

A worker presses the pressing portion with a thumb while an index finger is placed on the finger placing portion. At this time, the projection restricts a positional deviation of the index finger. Thus, there is no possibility that the index finger deviates from the finger placing portion and unlocking work efficiency is good.

The invention may include a tubular wire insertion portion bent and extending in the same direction as a projecting direction of the projection from the tubular surrounding portion. A part of an outer periphery of the wire insertion portion may serve as a finger receiving portion disposed to face the projection across the finger placing portion. The index finger placed on the finger placing portion is sandwiched between the projection and the finger receiving portion. Thus, the index finger cannot deviate from the finger placing portion.

A thickness of the projection may be larger than that of the finger placing portion. Thus, the rigidity of the projection is higher than that of the finger placing portion. Accordingly, the reliability of restricting the deviation of the index finger from the finger placing portion is excellent.

A fitting opening may be open in a front surface of the tubular surrounding portion for receiving the housing. A front surface of the projection may be disposed on a foremost end of the tubular surrounding portion, and a thickness of a part of a front part of the tubular surrounding portion where the projection is formed may be larger than that of a part where the projection is not formed. In fitting the housing into the tubular surrounding portion, the front part of the tubular surrounding portion may be folded and resiliently deformed inward by friction with the housing and caught between the inner periphery of the tubular surrounding portion and the outer periphery of the housing. However, the thickness of the projection is large. Thus, there is no possibility that the front part of the tubular surrounding portion is caught between the tubular surrounding portion and the housing.

The projection is formed with a detection recess capable of accommodating a rib of a mating connector as a connection partner to the housing. According to this configuration, a connected state of the housing and the mating connector can be detected on the basis of whether or not the rib is accommodated in the detection recess.

A front surface of the projection may serve as an inspection contact surface against which an inspection probe is to be butted. According to this configuration, whether or not a combination of the housing and the rubber boot is correct can be detected utilizing the projection.

### BRIEF DESCRIPTION OF DRAWINGS

FIG. 1 is a perspective view of a connector of one embodiment.

FIG. 2 is a front view of the connector.

FIG. 3 is a section along X-X of FIG. 2.

FIG. 4 is a section along Y-Y of FIG. 2.

FIG. 5 is a perspective view of a rubber boot.

FIG. 6 is a bottom view of the rubber boot.

FIG. 7 is a side view in section of the rubber boot.

### DETAILED DESCRIPTION

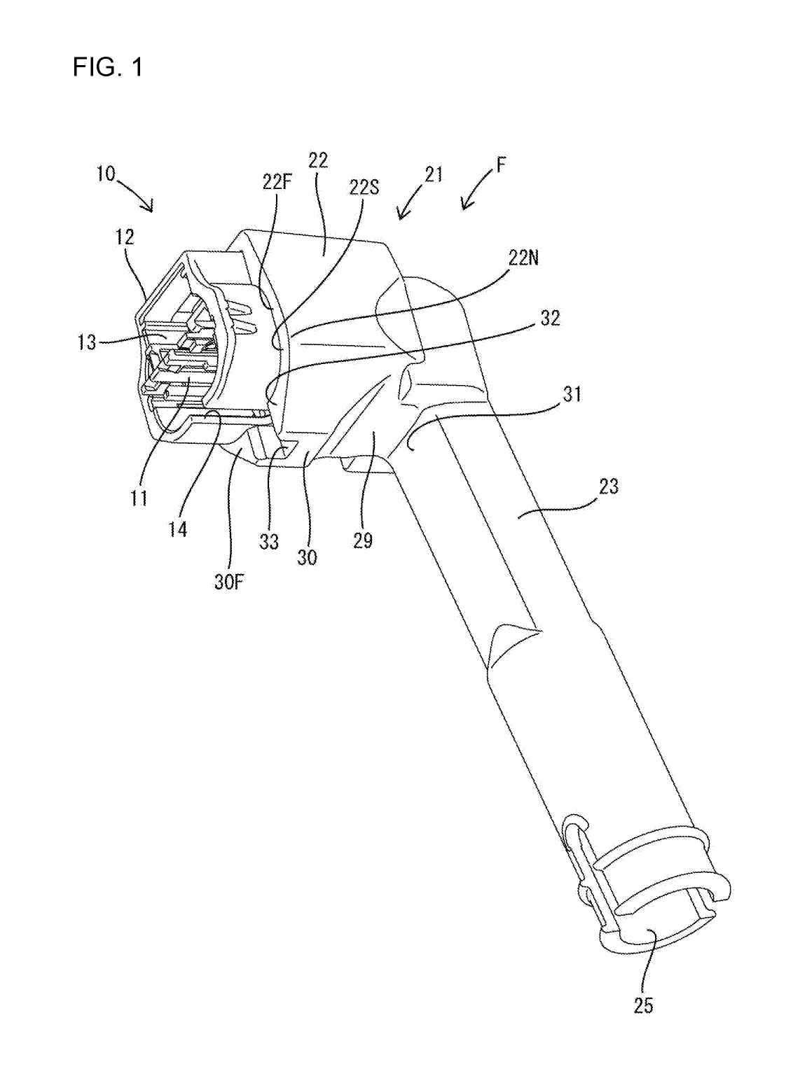

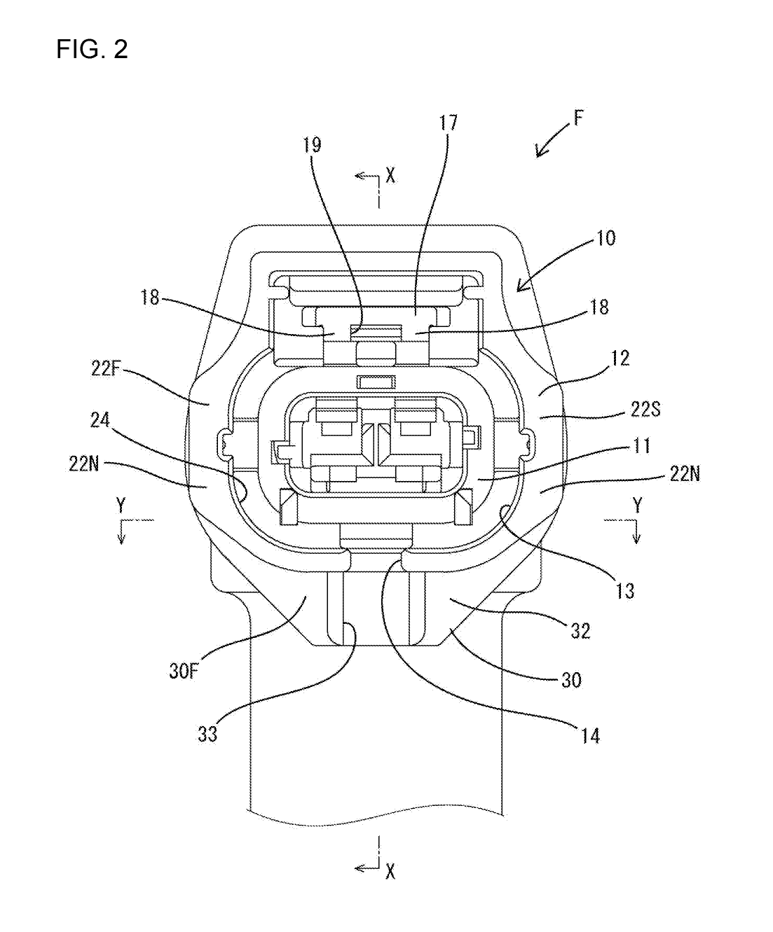

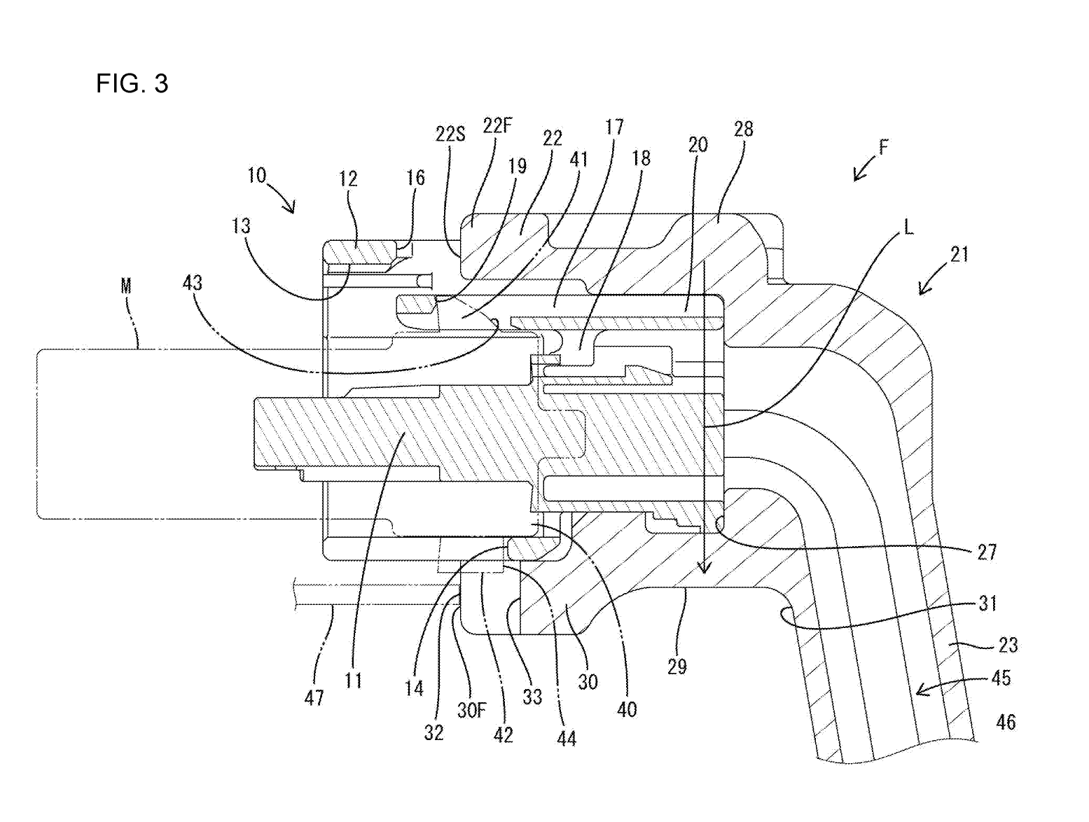

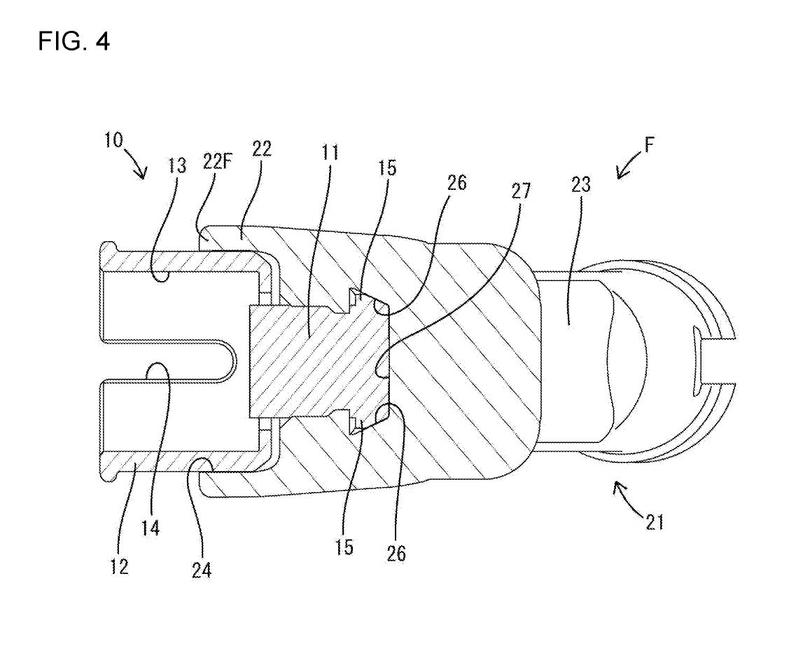

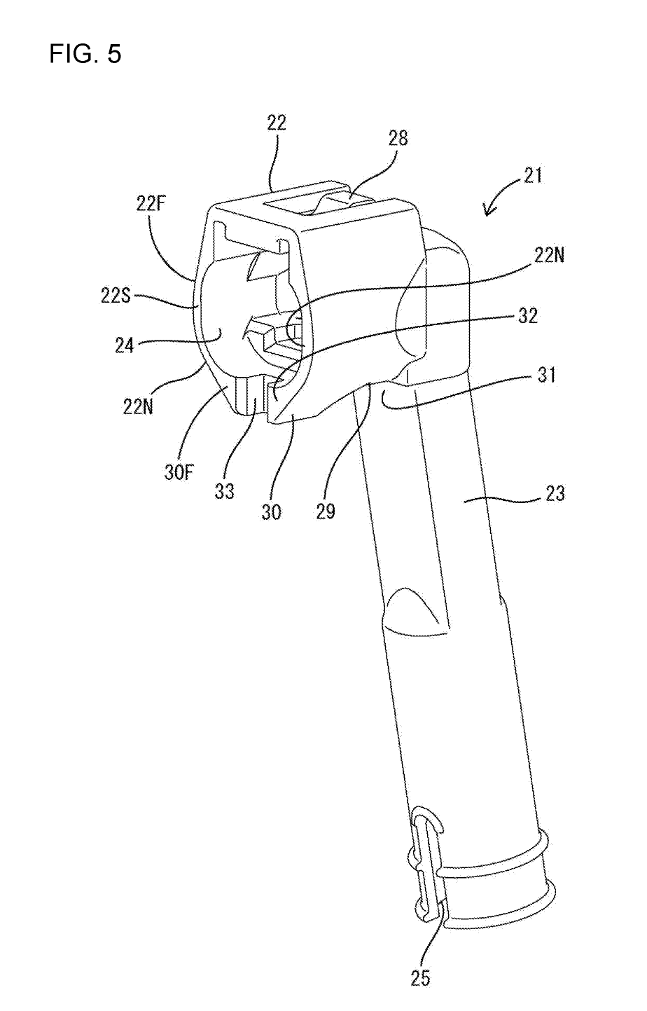

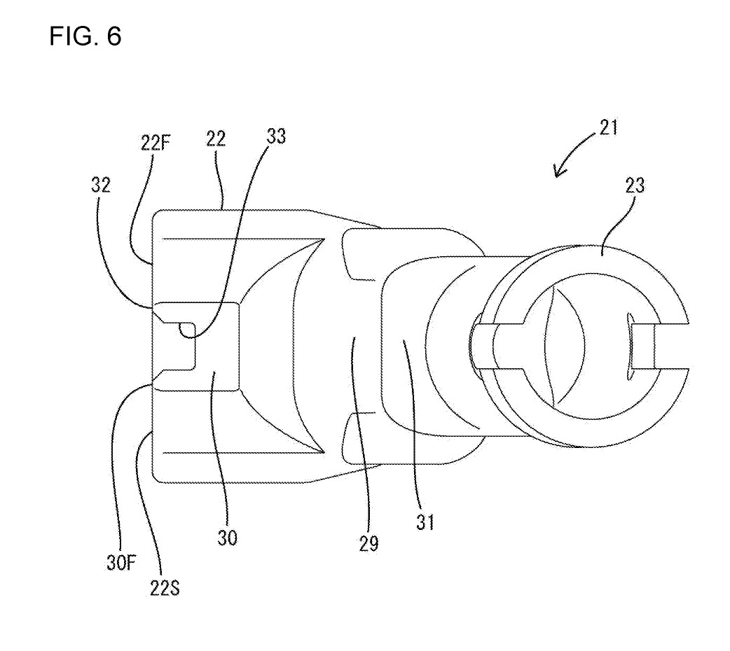

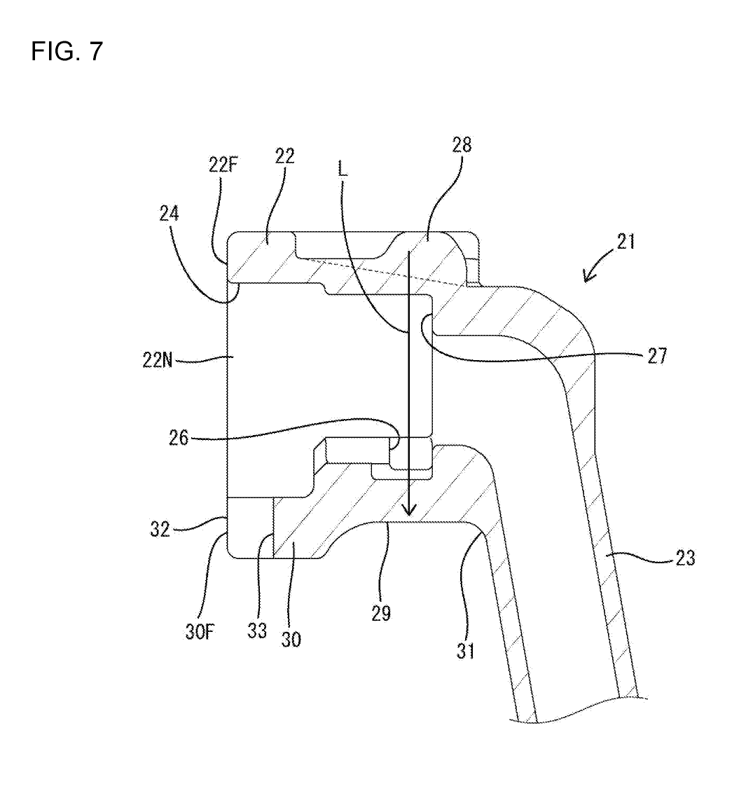

An embodiment of the invention is described with reference to FIGS. 1 to 7. A female connector F (connector as claimed) of this embodiment and a male connector M (mating connector as claimed) as a connection partner of the female connector F constitute, for example, an electric parking brake device. Note that, in the following description, a left side in FIGS. 1 and 3 to 7 is defined as a front side concerning a front-rear direction of the female connector F and a right side in FIG. 3 is defined as a front side concerning a front-rear direction of the male connector M. Upper and lower sides shown in FIGS. 1 to 3, 5 and 7 are defined as upper and lower sides concerning a vertical direction.

The male connector M is integral to a device body (not shown) and includes a receptacle 40 projecting horizontally forward to face the female connector F. A lock 41 projects on an upper surface on the outer periphery of the receptacle 40, and a rib 42 projects on a lower surface on the outer periphery of the receptacle 40. A front surface of the lock 41 facing the female connector F forms a guiding slope 43 inclined with respect to a connecting direction of the male and female connectors M, F. A front surface of the rib 42 facing the female connector F defines a locking surface 44 extending substantially at a right angle to the connecting direction of the male and female connectors M, F.

The female connector F is mounted on an end part of a wiring harness 45, and includes a housing 10 and a rubber boot 21 assembled with the housing 10. The housing 10 is configured by assembling components made of synthetic resin and includes a terminal accommodating portion 11 and a tubular fitting 12 surrounding the terminal accommodating portion 11. A female terminal fitting (not shown) connected to a wire 46 of the wiring harness 45 is inserted into the terminal accommodating portion 11 from behind the housing 10. The wire 46 is pulled horizontally out to the outside of the housing 10 from the rear surface of the housing 10.

A space enclosed by the outer periphery of the terminal accommodating portion 11 and the inner periphery of the tubular fitting 12 forms a connection space 13 open in the front of the housing 10. A guide groove 14 is formed in a lower surface of the tubular fitting 12 and extends straight rearward from the front end of the tubular fitting 12. The guide groove 14 communicates with the inner periphery (connection space 13) of the tubular fitting 12 from the outer periphery of the tubular fitting portion 12. Left and right locking projections 15 are formed on the lower surface of a rear end part of the outer periphery of a terminal accommodation chamber.

A cutout 16 is formed by cutting an upper surface part of the tubular fitting 12 except at a front end part, and an upper surface part of the connection space 13 of the housing 10 is open up through the cutout 16. The housing 10 is formed with a lock arm 17 for locking the female connector F and the male connector M in a connected state. The lock arm 17 is long in the front-rear direction, and a central part of the lock arm 17 in the front-rear direction is supported on the upper surface of the terminal accommodating portion 11 via a leg 18. A lock hole 19 is formed in a front part of the lock arm 17, and an unlocking portion 20 is formed on a rear end part of the lock arm 17.

The rubber boot 21 is a single member with a rear part of a tubular surrounding portion 22 having an axis oriented in the front-rear direction and an upper part of a tubular wire insertion portion 23 having an axis oriented substantially oriented vertically. A fitting opening 24 is open in a front end surface 22S of the tubular surrounding portion 22 (rubber boot 21) and an internal space of the tubular surrounding portion 22 is open forwardly of the tubular surrounding portion 22. The housing 10 is to be fit through the fitting opening 24 from the front of the rubber boot 21 and into the tubular surrounding portion 22.

An upper part of an internal space of the wire insertion portion 23 is bent forward and communicates with the internal space of the tubular surrounding portion 22. The lower end of the wire insertion portion 23 forms a wire draw-out opening 25 that is open downwardly. The wire 46 (wiring harness 45) is to be drawn out to the outside of the rubber boot 21 through the wire draw-out opening 25. Left and right locking recesses 26 are formed in a lower part of the inner periphery of the tubular surrounding portion 22.

In assembling the rubber boot 21 and the housing 10, the wire 46 is inserted through the fitting opening 24 from front of the rubber boot 21, inserted into the tubular surrounding portion 22 and the wire insertion portion 23 and drawn out to the outside of the rubber boot 21 from the wire draw-out opening 25 of the wire insertion portion 23. Subsequently, the housing 10 is fit through the fitting opening 24 from the front of the rubber boot 21.

With the rubber boot 21 assembled with the housing 10, the tubular surrounding portion 22 surrounds the housing 10 over the entire periphery except at a front part. The outer periphery of the rear end surface of the housing 10 butts against a stopper 27 on the back surface of the tubular surrounding portion 22, thereby restricting a rearward relative displacement of the housing 10 with respect to the rubber boot 21. The locking projections 15 of the housing 10 are locked to the locking recesses 26 of the tubular surrounding portion 22, thereby restricting a forward displacement of the housing 10 with respect to the rubber boot 21. Thus, the housing 10 and the rubber boot 21 are held assembled.

A pressing portion 28 is formed on an upper surface of the outer periphery of the tubular surrounding portion 22. The pressing portion 28 is in a part corresponding to the unlocking portion 22 both in the front-rear direction (axial direction of the tubular surrounding portion 22) and a lateral direction (circumferential direction of the tubular surrounding portion 22). The pressing portion 28 is thicker (dimension from the inner peripheral surface of the tubular surrounding portion 22 to the outer surface of the pressing portion 28) than an area of the tubular surrounding portion 22 adjacent to the pressing portion 28. Thus, rigidity is enhanced. When the outer or upper surface of the pressing portion 28 is pressed, the pressing portion 28 is displaced resiliently, the unlocking portion 20 is displaced down integrally with the pressing portion 28 and the lock arm 17 is displaced resiliently in an unlocking direction.

A finger placing portion 29 is formed on a lower surface part of the outer periphery of the tubular surrounding portion 22. The finger placing portion 29 is disposed at a position vertically opposite to the pressing portion 28 (unlocking portion 20) across the housing 10. In unlocking the lock arm 17, a worker presses the pressing portion 28 down with a thumb facing forward and places a laterally oriented index finger on the finger placing portion 29. Since the index finger is disposed on a line of action L extending in a pressing direction from the pressing portion 28, a pressing force by the thumb can be received from below by the index finger. Thus, if the index finger is placed on the finger placing portion 29, the pressing operation (unlocking operation) by the thumb can be performed stably.

However, if the position of the index finger deviates forward or rearward from the finger placing portion 29 (line of action of the pressing force), the pressing force by the thumb cannot be received from below by the index finger and the pressing operation (unlocking operation) by the thumb cannot be performed stably. Accordingly, the rubber boot 21 of this embodiment is formed integrally with a projection 30 and a finger receiving portion 31 for preventing a forward positional deviation of the index finger.

The projection 30 projects down from the lower surface of the outer periphery of the tubular surrounding portion 22. A thickness (distance from the inner peripheral surface of the tubular surrounding portion 22 to a lower surface, which is a projecting end of the projection 30) of the projection 30 exceeds that of the finger placing portion 29. The projection 30 is in front of and adjacent to the finger placing portion 29 in the front-rear direction, and is at the same position (laterally central part of the tubular surrounding portion 22) as the finger placing portion 29 in the lateral direction. The rear surface of the projection 30 is arcuate in a side view and is connected smoothly and tangentially to a front end part of the finger placing portion 29.

The projection 30 is in front of the unlocking portion 20 in the front-rear direction. The index finger placed on the finger placing portion 29 contacts the arcuate rear surface of the projection 30 or approaches and faces the arcuate rear surface of the projection 30 from behind. Thus, the index finger is not deviated positionally forward from the finger placing portion 29.

The finger receiving portion 31 constitutes the outer periphery of an upper end part of the wire insertion portion 23. The wire insertion portion 23 is connected to the rear end part of the tubular surrounding portion 22 and extends down (substantially in the same direction as the projection 30) from the tubular surrounding portion 22. The finger placing portion 29 is disposed on the rear part of the tubular surrounding portion 22. Thus, the finger receiving portion 31 is behind and adjacent to the finger placing portion 29 in the front-rear direction. Further, the finger receiving portion 31 is in the central part of the rubber boot 21 (tubular surrounding portion 22 and wire insertion portion 23) in the lateral direction, similarly to the finger placing portion 29 and the projection 30.

The finger receiving portion 31 is behind the unlocking portion 20 in the front-rear direction. The index finger placed on the finger placing portion 29 contact the front surface of the finger receiving portion 31 or approaches and faces the front surface of the finger receiving portion 31 from the front. Thus, the index finger is not deviated positionally rearward from the finger placing portion 29.

Further, a front surface 30F of the projecting portion 30 is a flat surface perpendicular to the connecting direction of the connectors F, M and an assembling direction of the housing 10 with the rubber boot 21 (tubular surrounding portion 22). The projection 30 is disposed on a front part 22F of the tubular surrounding portion 22. The front end surface 30F of the projection 30 is continuous and flush with an area of the front end surface 22S of the tubular surrounding portion 22 except the projection 30 in a circumferential direction. In other words, the front surface 30F of the projection 30 is at a foremost end of the tubular surrounding portion 22. This front surface 30F of the projection 30 functions as an inspection contact surface 32 against which an inspection probe 47 is to be butted during a continuity inspection.

Similar to the area of the front part 22F of the tubular surrounding portion 22 where the projection 30 is not formed, the projection 30 constitutes an opening edge of the fitting opening 24. A thickness of the projection 30 exceeds that of an adjacent area 22N of the tubular surrounding portion 22 circumferentially connected to the projection 30. Thus, the rigidity of the front part 22F of the tubular surrounding portion 22 is higher in a part where the projection 30 is formed than in the adjacent area 22N adjacent to the projection 30.

The front surface 30F of the projection 30 has a detection recess 33. The detection recess 33 is open in the inner peripheral surface and the outer peripheral surface of the tubular surrounding portion 22 and is at a position corresponding to the guide groove 14 in the lateral direction. Further, in the front-rear direction, the front surface 30F of the projection 30 is behind the front end of the housing 10 (guide groove 14), but the rear end of the detection recess 33 is slightly behind the rear end of the guide groove 14. A dimension of the detection recess 33 in the front-rear direction is smaller than that of the rib 42 of the male connector M in the front-rear direction.

In connecting the female connector F to the male connector M, the terminal accommodating portion 11 is fit into the receptacle 40, the tubular surrounding portion 22 is fit externally to the receptacle 40 and the receptacle 40 is inserted into the connection space 13. In a connection process, the front part of the lock arm 17 contacts the guiding slope 43 of the lock projection 41. Thus, the lock arm 17 is displaced resiliently in a seesaw manner to displace the front part up (unlocking direction away from the upper surface of the terminal accommodating portion 11) with the leg 18 as a supporting.

During this time, the rib 42 of the male connector M is inserted into the guide groove 14 of the female connector F and both left and right outer side surfaces of the rib 42 slide in contact with both left and right inner side surfaces of the guide groove 14. Thus, the prying of the connectors F, M in the lateral direction is prevented. Note that a lower part of the rib 42 projects out (down) from the outer or lower surface of the housing 10 while the rib 42 slides in the guide groove 14. When the connectors F, M reach a properly connected state, the lock arm 17 resiliently returns and the lock hole 19 is locked to the lock projection 41. The connectors F, M are locked in the properly connected state by a locking action of the lock hole 19 and the lock projection 41.

With the connectors F, M partly connected (state before reaching proper connection), the rib 42 of the male connector M has not reached an accommodation recess of the rubber boot 21 and the entire rib 42 is in front of the front surface 22S of the tubular surrounding portion 22. Further, when the connectors F, M reach the properly connected state, the rib 42 reaches a back part of the guide groove 14 and a front part of the rib 42 is accommodated in the detection recess 33. In this state, only a rear part of a lower end part of the rib 42 is exposed to the outside of the housing 10 and the rubber boot 21 in a side view.

According to this embodiment, the projection 30 is formed with the detection recess 33 capable of accommodating the rib 42 of the male connector M as a connection partner to the housing 10 (female connector F). Thus, the connected state of the housing 10 and the male connector M can be detected on the basis of whether the entire rib 42 is outside the detection recess 33 or the front part of the rib 42 is in the detection recess 33.

If the female connector F is going to be fit in a vertically inverted improper posture to the male connector M, the lock projection 41 is inserted into the guide groove 14, the rib 42 approaches the lock arm 17 and the locking surface 44 of the rib 42 butts against the front edge of the lock arm 17 during fitting. The locking surface 44 is substantially at a right angle to the connecting direction of the connectors F, M. Thus, the lock arm 17 and the rib 42 interfere with each other and any further connecting operation of the female connector F is restricted. If the connecting operation of the female connector F is restricted halfway, it can be detected that the female connector F has been fit in an improper orientation.

To separate the locked connectors F, M, the unlocking portion 20 is pushed down (in the unlocking direction) to approach the upper surface of the terminal accommodating portion 11 and to displace the lock arm 17 resiliently to an unlocking posture by pressing the pressing portion 28 of the rubber boot 21. When the lock arm 17 reaches the unlocking posture, the lock hole 19 is displaced up to disengage from the lock projection 41 and to unlock the lock arm 17. Thereafter, the female connector F may be pulled apart from the male connector M with the lock arm 17 kept in the unlocked state.

A worker unlocks the lock arm 17 by placing a thumb on the pressing portion 28 on the upper surface of the rubber boot 21 and placing an index finger on the finger placing portion 29 on the lower surface of the rubber boot 21 to sandwich the housing 10 vertically via the tubular surrounding portion 22 between the thumb and the index finger. At this time, the index finger placed on the finger placing portion 29 is sandwiched in the front-rear direction between the projection 30 on a front side and the finger receiving portion 31 on a rear side. Thus, the index finger cannot deviate forward or rearward from the finger placing portion 29. The thumb also cannot deviate from the pressing portion 28 so that a pressing operation to unlock the lock arm 17 can be performed stably.

The female connector F of this embodiment includes the housing 10 having the lock arm 17 disposed on the outer peripheral surface and the rubber boot 21 having the tubular surrounding portion 22 to be fit externally on the housing 10. The rubber boot 21 includes the pressing portion 28, the finger placing portion 29 and the projection 30. The pressing portion 28 is formed in the part corresponding to the unlocking portion 20 of the lock arm 17, and the unlocking portion 20 is pushed in the unlocking direction by pressing the pressing portion 28 toward the housing 10. The finger placing portion 29 is opposite to the pressing portion 28 across the housing 10. By placing the index finger on the finger placing portion 29, a downward pressing force applied to the pressing portion 28 from the thumb can be received by the index finger.

The projection 30 is in the part adjacent to the finger placing portion 29 and projects radially from the finger placing portion 29. In unlocking the lock arm 17, the worker presses the pressing portion 28 with the thumb while the index finger is placed on the finger placing portion 29. At this time, the projection 30 restricts positional deviation of the index finger so that the index finger cannot deviate from the finger placing portion 29 and unlocking work efficiency is good.

The rubber boot 21 includes the tubular wire insertion portion 23 bent and extending in the same direction (down) as the projecting direction of the projection 30 from the rear end of the tubular surrounding portion 22. A front part of the outer periphery of the upper end part of the wire insertion portion 23 serves as the finger receiving portion 31 and faces the projection 30 in the front-rear direction across the finger placing portion 29. Accordingly, the index finger placed on the finger placing portion 29 is sandwiched between the projection 30 and the finger receiving portion 31 so that the index finger cannot deviate from the finger placing portion 29.

The thickness of the projection 30 is set larger than that of the finger placing portion 29 such that the rigidity of the projection 30 is higher than the rigidity of the finger placing portion 29. Thus, even if the index finger is pressed strongly against the projection 30, there is no possibility that the projection 30 of improper forward deformation. Therefore, the reliability of restricting the deviation of the index finger from the finger plating portion 29 is excellent. Further, the large thickness of the projection 30 means that the area of the front surface 30F of the projecting portion 30 is wide. Focusing on this point, the front surface 30F of the projection 30 can function as the inspection contact surface 32 against which the inspection probe 47 can be abutted. Bringing the inspection probe 47 into contact with the inspection contact surface 32 enables a detection of whether or not a combination of the housing 10 and the rubber boot 21 is correct.

Further, the fitting opening 24 through which the housing 10 is to be fit from the front is open in the front surface 22S of the tubular surrounding portion 22. In fitting the housing 10 into the tubular surrounding portion 22, the front part 22F of the tubular surrounding portion 22 may be folded and resiliently deformed by friction with the housing 10 and caught between the inner periphery of the tubular surrounding portion 22 and the outer periphery of the housing 10.

Accordingly, the thickness of the part of the front part 22F of the tubular surrounding portion 22 where the projection 30 is formed is larger than that of the part where the projection 30 is not formed, and the front surface 30F of the projection 30 is disposed on the foremost end of the tubular surrounding portion 22. As a result, rigidity is high in the projection 30 having a partly large thickness, and the front part 22F of the tubular surrounding portion 22 is prevented from being caught between the tubular surrounding portion 22 and the housing 10.

The invention is not limited to the above described embodiment. For example, the following embodiments also are included in the scope of the invention.

Although the projection is adjacent and in front of the finger placing portion in the above embodiment, the projection may be adjacent and behind the finger placing portion or adjacent both in front of and behind the finger placing portion.

Although the thickness of the projection is larger than that of the finger placing portion in the above embodiment, the thickness of the projection may be smaller than that of the finger placing portion or may be set equal to that of the finger placing portion.

Although the finger receiving portion is on the outer periphery of the wire insertion portion in the above embodiment, the finger receiving portion may be elsewhere.

Although the wire insertion portion is bent and extends in the same direction as the projecting direction of the projection from the tubular surrounding portion in the above embodiment, the wire insertion portion may extend in a different direction.

Although the front surface of the projection is on the foremost end of the tubular surrounding portion in the above embodiment, the front end surface of the projection may be at a position behind the foremost end of the tubular surrounding portion.

Although the area of the front end surface of the tubular surrounding portion constituting the projection and the area thereof not constituting the projection are continuous and flush with each other in the above embodiment, the area of the front end surface of the tubular surrounding portion constituting the projection may be at a position deviated in the front-rear direction from the area not constituting the projection.

Although the projection is formed with the detection recess for accommodating the rib of the mating connector in the above embodiment, the projection may not be formed with the detection recess.

Although the front end surface of the projection functions as the inspection contact surface against which the inspection probe is to be butted in the above embodiment, the front end surface of the projection may not function as the inspection contact surface.

### LIST OF REFERENCE SIGNS

F . . . female connector (connector)
M . . . male connector (mating connector)
10 . . . housing
17 . . . lock arm
20 . . . unlocking portion
21 . . . rubber boot
22 . . . tubular surrounding portion
22F . . . front end part of tubular surrounding portion
23 . . . wire insertion portion
24 . . . fitting opening
28 . . . pressing portion
29 . . . finger placing portion
30 . . . projection
30F . . . front end surface of projection
31 . . . finger receiving portion
33 . . . detection recess
42 . . . rib

What is claimed is:

1. A rubber boot (21), comprising:
a tubular surrounding portion (22) to be fit externally to a housing (10) having a lock arm (17) disposed on an outer peripheral surface;
a pressing portion (28) formed in a part corresponding to an unlocking portion (20) of the lock arm (17) and configured to press the unlocking portion (20) in an unlocking direction;
a finger placing portion (29) disposed at a position opposite to the pressing portion (28) across the housing (10) and configured to receive a pressing force applied to the pressing portion (28); and
a projection (30) disposed in a part adjacent to the finger placing portion (29) on the outer periphery of the tubular surrounding portion (22) and projecting from the finger placing portion (29).

2. The rubber boot (21) of claim 1, comprising a tubular wire insertion portion (23) bent and extending in the same direction as a projecting direction of the projection (30) from the tubular surrounding portion (22), wherein:
a part of an outer periphery of the wire insertion portion (23) serves as a finger receiving portion (31) disposed to face the projection (30) across the finger placing portion (29).

3. The rubber boot of claim 2, wherein a thickness of the projection (30) is larger than that of the finger placing portion (29).

4. The rubber boot of claim 3, wherein:
a fitting opening (24) through which the housing (10) is to be fit from the front is open in a front surface (22F) of the tubular surrounding portion (22);
a front surface (30F) of the projection (30) is disposed on a foremost end of the tubular surrounding portion (22); and
a thickness of a part of a front part of the tubular surrounding portion (22) where the projection (30) is formed is set larger than that of a part thereof where the projection (30) is not formed.

5. The rubber boot of claim 4, wherein the projection (30) is formed with a detection recess (33) capable of accommodating a rib (42) of a mating connector (M) as a connection partner to the housing (10).

6. The rubber boot of claim 5, wherein the front end surface (30F) of the projection (30) serves as an inspection contact surface against which an inspection probe is to be butted.

7. The rubber boot of claim 1, wherein a thickness of the projection (30) is larger than that of the finger placing portion (29).

8. The rubber boot of claim 1, wherein:
a fitting opening (24) through which the housing (10) is to be fit from the front is open in a front surface (22F) of the tubular surrounding portion (22);
a front surface (30F) of the projection (30) is disposed on a foremost end of the tubular surrounding portion (22); and
a thickness of a part of a front part of the tubular surrounding portion (22) where the projection (30) is formed is set larger than that of a part thereof where the projection (30) is not formed.

9. The rubber boot of claim 1, wherein the projection (30) is formed with a detection recess (33) capable of accommodating a rib (42) of a mating connector (M) as a connection partner to the housing (10).

10. The rubber boot of claim 1, wherein a front surface (30F) of the projection (30) serves as an inspection contact surface against which an inspection probe is to be butted.

11. A connector (F), comprising:
a housing (10) having a lock arm (17) disposed on an outer peripheral surface;
a rubber boot (21) including a tubular surrounding portion (22) to be fit externally to the housing (10);
a pressing portion (28) formed in a part corresponding to an unlocking portion (20) of the lock arm (17) and configured to press the unlocking portion (20) in an unlocking direction;
a finger placing portion (29) disposed at a position opposite to the pressing portion (28) across the housing (10) and configured to receive a pressing force applied to the pressing portion (28); and
a projection (30) disposed in a part adjacent to the finger placing portion (29) on the outer periphery of the tubular surrounding portion (22) and radially projecting from the finger placing portion (29).
